(19) United States
(12) Patent Application Publication
(10) Pub. No.: US 2008/0237205 A1
(43) Pub. Date: Oct. 2, 2008

(54) SMALL HOLE LASER MACHINING METHOD

(75) Inventors: Takashi Kobayashi, Hagagun (JP); Hiroaki Yamagishi, Hagagun (JP); Akihiro Nemoto, Hagagun (JP); Katsuyuki Nakajima, Hagagun (JP)

Correspondence Address: RANKIN, HILL & CLARK LLP, 38210 Glenn Avenue, WILLOUGHBY, OH, 44094-7808, US

(73) Assignee: HONDA MOTOR CO., LTD., Tokyo (JP)

(21) Appl. No.: 12/056,526

(22) Filed: Mar. 27, 2008

(30) Foreign Application Priority Data
Mar. 28, 2007 (JP) 2007-085269

(51) Int. Cl. B23K 26/38

(52) U.S. Cl. 219/121.71

(57) ABSTRACT

A method of laser machining a small hole with high machining precision in a machined object. The method includes the steps of emitting a laser beam with a fixed optical axis onto a machined object while the machined object is rotated. When the optical axis of the laser beam is fixed in place, the edges of the small hole to be machined are irradiated and the small hole becomes essentially circular even if the cross-sectional shape at the focus of the laser beam is not circular. When the small hole is formed completely through the machined object, a plume is suctioned for removal from a portion of the machined object on a side opposite from the machined hole.

### FIELD OF THE INVENTION

The present invention relates to an improvement in a method of laser machining or forming a small hole in a machined object.

### BACKGROUND OF THE INVENTION

A method of machining small holes in which pilot holes are formed in a workpiece using a laser beam and are then finished by electrical discharge machining is disclosed in Japanese Patent Application Laying-Open Publication No. 2001-150248 (JP 2001-150248 A). Referring to FIG. 7 hereof, the disclosed machining method will be described below.

As shown in FIG. 7, a laser machining head 101 moves directly above a position for machining a hole in a workpiece 102, a laser beam 103 is emitted from the laser machining head 101 onto the workpiece 102, and a pilot hole is formed in the workpiece 102 in a machining fluid.

When small holes are opened using the laser beam 103, the cross-section of the laser beam 103 in focal position may not be circular, and the precision of the internal diameter and the roundness of the opened small holes may be poor even if the laser beam 103 is focused. There is a method of rotating the laser beam 103 using a beam rotator, a Galvano mirror, or the like in order to increase machining accuracy, but this affects the shape of the focus cross-section described above, making it difficult to greatly increase machining accuracy.

In particular, a thermal modification layer in which the structure in the base material is changed is readily formed in the periphery of the hole which has been machined in a state in which the laser beam 103 is stationary because the energy density of the laser beam 103 is high.

### SUMMARY OF THE INVENTION

It is therefore an object of the present invention to increase the accuracy of machining of a small hole and to make a thermal modification layer less likely to occur.

According to the present invention, there is provided a method of laser machining a small hole in a machined object by emitting a laser beam onto the object, which method comprising the steps of: rotating the machined object; emitting the laser beam onto the rotated machined object with an optical axis of the laser beam fixed in place; and suctioning, after the small hole is formed, a plume from a portion of the machined object on a side opposite from a machined part of the object.

In this arrangement, since the same portion of the cross-sectional shape stationary focus constantly strikes the edge of the small hole to be opened in the rotating machined object, the shape of the small holes will be circular or nearly circular when the optical axis of the laser beam is fixed while the machined object is rotated, even if the cross section at the focus of the laser beam is not circular. For this reason, circular machining accuracy is substantially achieved without being affected by the cross-sectional shape at the focus of the laser beam.

Since plumes are removed from the reverse side of the machined object after a small hole has been formed, laser light is not obstructed, absorbed, or scattered by plumes, and the laser beam makes constant contact with the rotating machined object.

Preferably, the machined object is irradiated with the laser beam in an inert gas atmosphere.

In a preferred form, the plume generated during machining of the machined object is removed by a suction tube disposed in the vicinity of an opening of a hole being machined.

### BRIEF DESCRIPTION OF THE DRAWINGS

Certain preferred embodiments of the present invention will be described in detail below, by way of example only, with reference to the accompanying drawings, in which:

FIG. 1 is a side elevational view showing a fuel injection valve to be machined by a machining method according to the present invention;

FIG. 2 is an enlarged cross-sectional view showing an injection port formed at a distal end of a nozzle of the fuel injection valve shown in FIG. 1;

FIG. 3 is a cross-sectional view showing a laser machining apparatus for implementing the laser machining method according to the present invention;

FIGS. 4A to 4C are schematic views illustrating laser machining performed, in accordance with the present invention, with an optical axis of a laser beam fixed in place and the nozzle body being rotated;

FIG. 5 is a cross-sectional view showing removal suctioning of plumes generated during the laser machining;

FIGS. 6A and 6B are views illustrating a relationship between the machined hole and the laser beam in conventional laser machining and in the inventive laser machining; and

FIG. 7 is a schematic view illustrating a conventional small hole laser machining method.

### DETAILED DESCRIPTION OF THE PREFERRED EMBODIMENTS

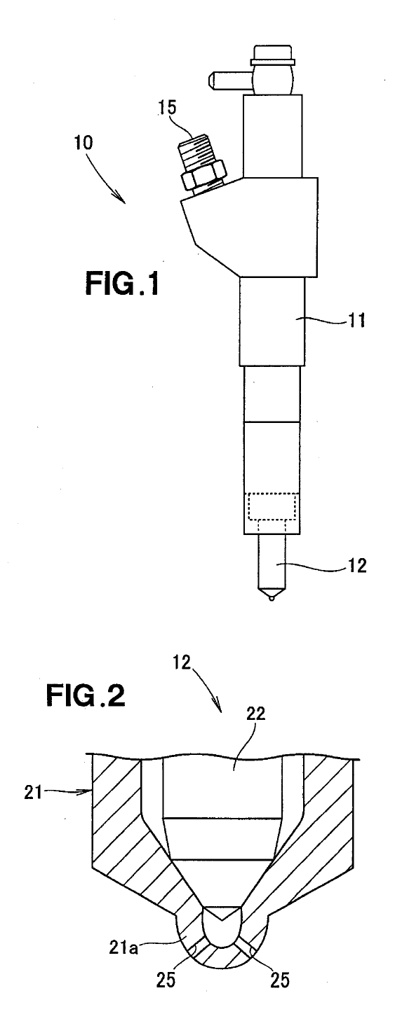

Reference is now made to FIGS. 1 and 2 showing a fuel injection valve and nozzle with a small hole opened using the laser machining method according to the present invention.

The fuel injection valve 10 shown in FIG. 1 is composed of a nozzle holder 11 and a nozzle 12 that is held at the distal end of the nozzle holder 11. Fuel is taken in through the inlet 15.

As shown in FIG. 2, the nozzle 12 is a hole-type nozzle and is composed of a nozzle body 21 and a nozzle needle 22 that opens and closes the fuel channel of the nozzle body 21.

The nozzle body 21 has a distal end portion 21a that protrudes downward. The tip 21a has a plurality of injection ports 25 that inject fuel. These injection ports 25 are opened using the method of laser machining a small hole according to the present invention.

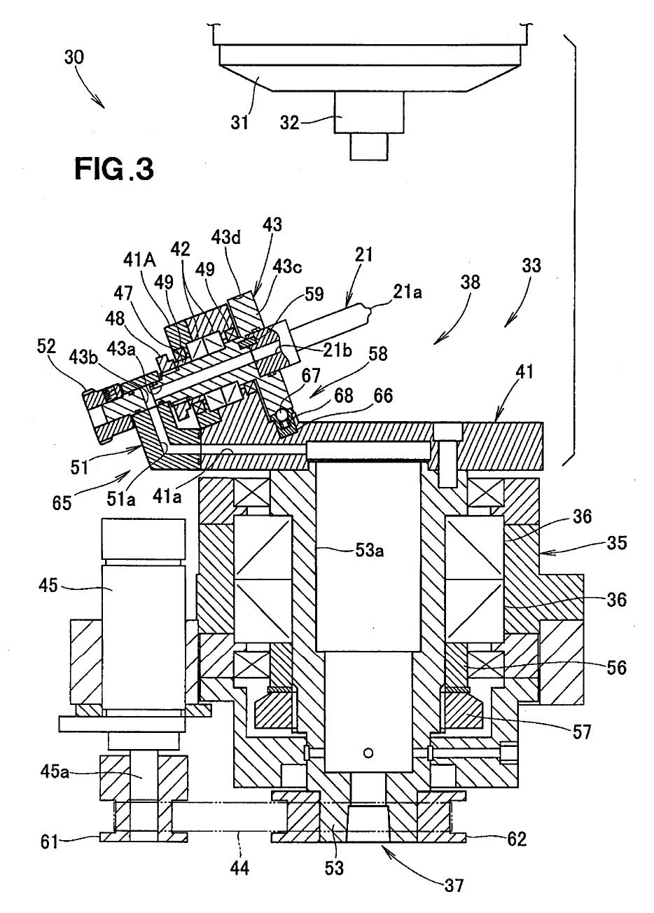

FIG. 3 shows a laser machining apparatus 30 used when the method of the present invention is implemented.

The laser machining apparatus 30 comprises a laser oscillator 31, a machining head 32 provided on the lower portion of the laser oscillator 31 for emitting a laser beam, and a workpiece support part 33 disposed below the machining head 32.

The workpiece support part 33 is composed of a base portion 35, a rotating portion 37 rotatably supported by bearings 36 and 36 on the base portion 35, a workpiece holding portion 38 provided on an upper portion of the rotating portion 37, and a drive motor 45 for rotatingly driving the rotating portion 37 via a belt 44.

The rotating portion 37 has a rotating cylindrical member 53 that is supported by the bearings 36 and 36. The rotating cylindrical member 53 is mounted on the bearings 36 and 36 by using a collar 56 and a nut 57.

A drive pulley 61 is mounted on a rotating shaft 45a of the drive motor 45. A driven pulley 62 is mounted on the lower portion of the rotating cylindrical member 53. The belt 44 is wound around the drive pulley 61 and the driven pulley 62.

The workpiece holding member 38 includes a holding base 41 mounted on the rotating cylindrical member 53. The workpiece-holding main body 43 is rotatably mounted on the holding base 41 by way of bearings 42 and 42. A collar 47 and a nut 48 prevent the bearings 42 and 42 from separating from the workpiece-holding main body 43. An annular member 41A is mounted on the holding base 41 in order to support one of seals 49 and 49 positioned on the two sides of the bearings 42 and 42.

The workpiece holding member 38 also includes an extension member 51 that extends from the holding base 41 to the distal end side of the workpiece-holding main body 43 in order to support one end of the workpiece-holding main body 43. Driven gear 52 which receives driving power from the driving apparatus (not shown) that rotates the workpiece-holding main body 43 is mounted on the distal end of the workpiece holding device 43. A workpiece rotation angle indexing mechanism 58 positions the workpiece holding device 43 at each prescribed rotational angle.

The positioning pin 59 stops the rotation of the nozzle body 21 with respect to the workpiece-holding main body 43 when the nozzle body 21 as the workpiece is supported by the workpiece-holding main body 43.

The workpiece-holding main body 43 has a pathway 43a that passes through to a pathway 21b inside the nozzle body 21, and also has a pathway 43b that is orthogonal to the pathway 43a. Pathway 43b is in communication with a pathway 51a formed inside the extension member 51. This pathway 51 is in communication with a hollow portion 53a formed in the rotating cylindrical member 53 by way of the pathway 41a formed in the holding base 41.

The pathways 21b, 43a, 43b, 51a, and 41a, and the hollow portion 53a constitute a plume suction pathway 65 for suctioning plumes generated during laser machining (i.e., the ionized mixed gas or metallic vapors produced when the nozzle body 21 evaporates due to the heat).

A workpiece rotation angle indexing mechanism 58 is composed of a plurality of concavities 43d formed at prescribed angles in the circumferential direction on the external peripheral surface of a large-diameter portion 43c disposed on the workpiece-holding main body 43; a case 66 provided to the holding base 41 so as to face the external peripheral surface of the large-diameter portion 43c; a plurality of balls 67 that are disposed inside the case 66 and that can be fitted into the plurality of concavities 43d, respectively; and springs 68 disposed inside the case 66 in order to press each of the balls 67 into each concavity 43d.

The circumferential interval (angle) of adjacent concavities 43d and 43d conforms to the angle in the circumferential direction in which the plurality of injection ports 25 (FIG. 2) opened in the distal end portion 21a of the nozzle body 21 are adjacent to each other.

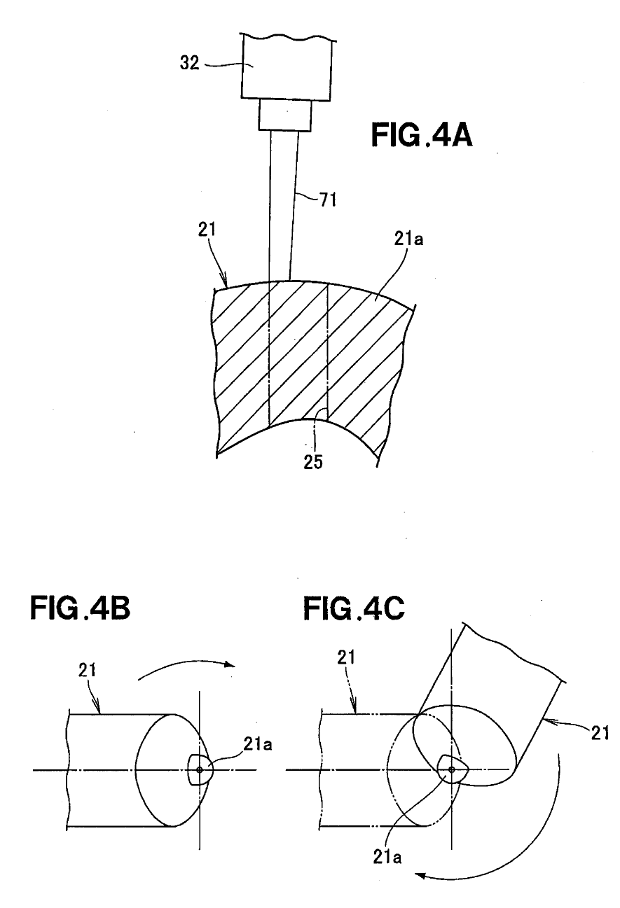

FIGS. 4A through 4C show a state in which the laser beam 71 is fixed in place while the nozzle body 21 is rotated as machining is performed.

In FIG. 4, the laser beam 71 is emitted from the machining head 32 in an inert gas atmosphere and is irradiated on the distal end portion 21a of the nozzle body 21. Injection ports 25 to be formed are shown using alternate long and two short dashes lines.

In FIG. 4B, the optical axis of the laser beam 71 shown in FIG. 3A is fixed in place during laser machining, and the nozzle body 21 is rotated in the direction of the arrow by the workpiece support part 33 (FIG. 2) while laser machining is performed

In FIG. 4C, the nozzle body 21 is furthermore rotated in the direction of the arrow. The nozzle body 21 is rotated at a constant speed in a fixed direction during laser machining.

FIG. 5 shows a state in which plumes 73 generated during machining are removed.

Since plumes 73 generated during laser machining may obstruct, absorb, or scatter the laser beam 71, plumes 73 are suctioned and removed through a suction tube 76 disposed in the vicinity of an opening of a hole 75 being machined.

When the hole 75 is formed completely through a workpiece, plumes are suctioned and removed from the nozzle body 21 through the plume suction pathway 65 shown in FIG. 2.

Suctioning off the plumes 73 in this manner prevents the machining performed by the laser beam 71 from being intermittent, continuous constant machining to be performed is a steady manner, and machining precision to be improved because the laser beam 71 is not obstructed, absorbed, or scattered by the plumes 73.

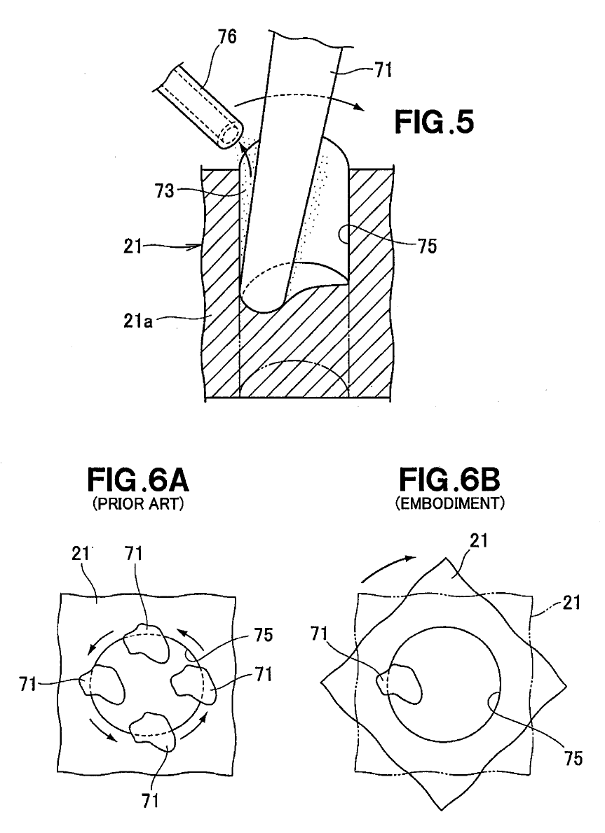

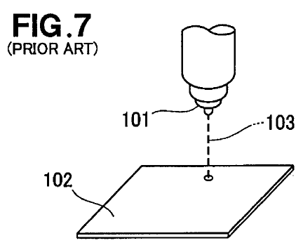

FIGS. 6A and 6B show the relationship between the hole and the laser beam in conventional laser machining and in the present invention.

In the conventional example shown in FIG. 6A, the nozzle body 21 is fixed in place and the laser beam 71 is rotated by a beam rotator or the like.

Since the cross-sectional shape at the focus of laser beam 71 is not circular, the shape of the laser beam 71 that makes contact with the edge of the hole 75 constantly varies when the laser beam 71 is rotated. For this reason, the shape of the hole 75 will not be circular. In other words, the shape of the hole 75 is affected by the cross-sectional shape at the focus of the laser beam 71. In the example shown in the diagram, the hole 75 has a shape that is nearly elliptical.

In the embodiment of FIG. 6, the optical axis of the laser beam 71 is fixed in place and the nozzle body 21 rotates in the direction of the arrow.

Fixing the optical axis of the laser beam 71 in place and rotating the nozzle body 21 in this manner allows the hole 75 to be circular or nearly circular because the cross-sectional shape at the focus of the laser beam 71 that makes contact with the edge of the hole 75 is the same all the time. Therefore, machining accuracy is improved so that the injection ports 25 (FIG. 2) are essentially circular in shape.

Obviously, various minor changes and modifications of the present invention are possible in light of the above teaching. It is therefore to be understood that within the scope of the appended claims the invention may be practiced otherwise than as specifically described.

1. A method of laser machining a small hole in a machined object by emitting a laser beam onto the object, the method comprising the steps of:
rotating the machined object;
emitting the laser beam onto the rotated machined object with an optical axis of the laser beam fixed in place; and
suctioning, after the small hole is formed, a plume from a portion of the machined object on a side opposite from a machined part of the object.

2. The method of laser machining the small hole of claim 1, wherein the machined object is irradiated with the laser beam in an inert gas atmosphere.

3. The method of laser machining the small hole of claim 1, wherein the plume generated during machining of the machined object is removed through a suction tube disposed in a vicinity of an opening of the hole being machined.
